(19) United States
(12) Patent Application Publication
(10) Pub. No.: US 2024/0193164 A1
(43) Pub. Date: Jun. 13, 2024

(54) LOW-CODE PROGRAMMING FOR ANALYTICS COMPUTING SYSTEM

(71) Applicant: SAP SE, Walldorf (DE)

(72) Inventor: Giancarlo FRISON, Mammendorf (DE)

(21) Appl. No.: 18/078,566

(22) Filed: Dec. 9, 2022

(51) Int. Cl. G06F 16/2455; G06F 16/242

(52) U.S. Cl. CPC G06F 16/24566; G06F 16/2425

(57) ABSTRACT

Various examples are directed to systems and methods in an analytics computing system. The analytics computing system may receive query data and an indication of a subject tuple. The analytics computing system may access analytics code comprising first proposition data corresponding to the subject tuple. The first proposition data may comprise proposition head data describing the subject tuple and proposition body data describing at least one proposition condition, the at least one proposition condition comprising a relationship between a first proposition body tuple and a second proposition body tuple. The analytics computing system may access query processing data and determine a subset of the query processing data for which the at least one proposition condition is true.

### BACKGROUND

Analytics computing systems are implemented for enterprises, such as business enterprises, to provide analysis of data. An analytics computing system may include software and/or hardware that are arranged to gather, integrate, analyze, and/or present insights regarding underlying data to various users.

### BRIEF DESCRIPTION OF DRAWINGS

The present disclosure is illustrated by way of example and not limitation in the following figures.

FIG. 1 is a diagram showing one example of an environment including an analytics computing system configured to execute analytics code implemented using tuple-based propositions.

FIG. 2 is a flowchart showing one example of a process flow that may be executed by the analytics computing system of FIG. 1 to respond to a query using tuple-based propositions.

FIG. 3 is a flowchart showing one example of a process flow that may be executed by the analytics computing system of FIG. 1 to evaluate a received query.

FIG. 4 is a flowchart showing another example of a process flow that may be executed by the analytics computing system of FIG. 1 to evaluate a query using tuple-based propositions.

FIG. 5 is a flowchart showing one example of a process flow that may be executed by the analytics computing system of FIG. 1 to evaluate a proposition including a recursive call.

FIG. 6 is a block diagram showing one example of an architecture for a computing device.

FIG. 7 is a block diagram of a machine in the example form of a computer system within which instructions may be executed for causing the machine to perform any one or more of the methodologies discussed herein.

### DETAILED DESCRIPTION

Analytics computing systems can provide enterprises with detailed analysis of data from different data sources. An analytics computing system is programmed to reflect business processes, technical processes, and/or other processes or systems. The analytics computing system accesses and analyzes available data according to its programming to provide enterprise users with data analysis that is consistent with the underlying business processes, technical processes, and/or the like.

Programming an analytics computing system to accurately and completely reflect an underlying business process, technical process, and/or the like can involve considerable challenges. For example, programming an analytics computing system may often involve multiple steps such as functional analysis of the processes and/or systems to be analyzed, architectural drafting laying out the software to be created, implementation of the software, and quality checking.

These different phases of software development for the analytics computing system often involve different staff having different roles and different training. For example, the functional analysis stage may involve users with subject matter expertise in the processes and/or systems being analyzed. Consider an example in which an accounting system is being analyzed. The functional analysis stage may involve one or more accountants or other non-software personnel with the subject matter expertise in the accounting system at the enterprise utilizing the analytics computing system. Consider another example in which a chemical manufacturing process is being analyzed. The functional analysis stage may involve chemical engineers, process engineers, and/or other non-software personnel who are subject matter experts in the chemical manufacturing process.

Other stages of analytics computing system programming may involve more software-oriented personnel. For example, many subject matter experts in accounting, human resources, sales, engineering, and/or the like may not have sufficient training to develop code to implement the results of the functional analysis and/or architectural drafting stage or to debug the code and perform other quality checking. As a result, the programming of an analytics computing system can involve engaging multiple teams of experts having different areas of expertise. This can add time, expense, and complication to the programming process.

In some examples, an enterprise utilizing an analytics computing system may provide some or all of its programming using a low-code or no-code arrangement. In a low-code or no-code arrangement, an analytics computing system may provide simplified tools that allow non-software expert users to implement desired functionality at the analytics computing system. Many low-code and no-code solutions, however, are limited to one or a few very simple scenarios and may not provide sufficient customization or flexibility for many enterprises.

Various examples described herein address these and other challenges by utilizing low-code programming techniques including tuple-based propositions. A tuple is a data arrangement including a predicate and at least two arguments. The predicate describes a relationship between the at least two arguments. Consider the example tuple data item expressed by Code Fragment [1] below:

(“hasPrice”, “Amarone redwine”, 23.34) [1]

The predicate “hasPrice” describes a relationship between a first argument “Amarone red wine” and a second argument “23.34.” In this example, the tuple indicates that “Amarone red wine” has a price of “23.34.”

A tuple-based proposition may include proposition head data and proposition body data. The proposition head data may describe a subject tuple. The proposition body data may describe one or more relationships between one or more proposition body tuples and/or other variables. The relationships expressed by the proposition body data are implied by the subject tuple.

The arguments of the subject tuple may act as input and/or output variables. Consider an example subject tuple having a first argument and a second argument. The analytics computing system may receive a query that indicates the subject tuple and provides a value for the first argument of the subject tuple. The analytics computing system may utilize the tuple-based proposition to determine a corresponding value for the second argument of the subject tuple. In some examples, the analytics computing system may also, or alternatively, receive a query that indicates the subject tuple and provides a value for the second argument of the subject tuple. The analytics computing system may utilize the tuple-based proposition to determine a corresponding value for the first argument of the subject tuple. Also, in some examples, the analytics computing system may receive a query that indicates the subject tuple but does not indicate values for any of the arguments. In this example, the analytics computing system may generate a reply that includes all data items including valid values for the arguments of the subject tuple.

The example analytics computing system programming techniques described herein may allow the analytics computing system to evaluate queries using matrix-based operations. For example, data accessible to the analytics computing system may be expressed as tuples in a matrix format. For example, a first column of the matrix may correspond to a first argument of the tuple. A second column of the matrix may correspond to a second argument of the tuple, and so on. Each row of the matrix may correspond to a tuple data item. A tuple data item may include values for some or all of the arguments of the tuple. The analytics computing system, in some examples, may evaluate the relationship between proposition body tuples by performing matrix-based operations on matrices representing available tuple data items corresponding to the proposition body tuples.

In various examples, the analytics computing system programming techniques described herein may simplify analytics computing system programming while minimizing any loss of programming flexibility. For example, because the programming is expressed in tuples, it may be understandable by non-software personnel. In some examples, non-software personnel may be capable of generating tuple-based propositions with minimal or no special training and software. Also, for example, analytics computing system programming techniques with tuple-based propositions may increase the efficiency of the analytics computing system by structuring processing in terms of matrix-based operations, as described herein.

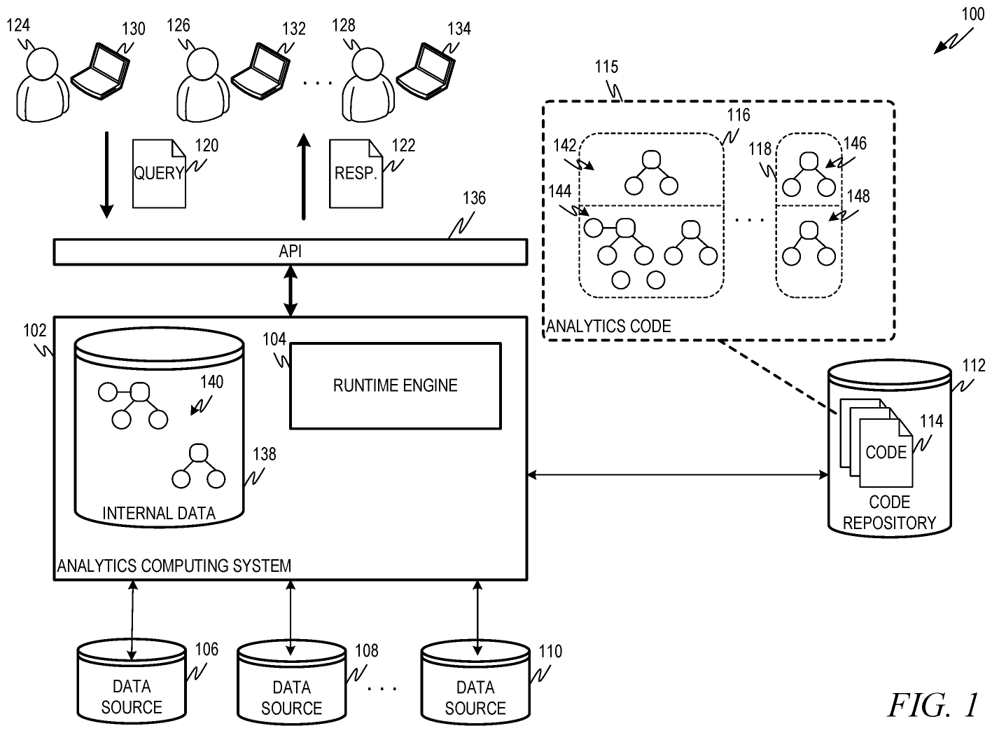

FIG. 1 is a diagram showing one example of an environment 100 including an analytics computing system 102 configured to execute analytics code 114 implemented using tuple-based propositions. The analytics computing system 102 can be configured to perform various tasks using analytics computing system 102 resources such as, for example, data sources 106, 108, 110 and model resources, such as one or more process and/or system models implemented by analytics code 114. Tasks performed by an analytics computing system 102 can include, for example, providing various reports, forecasts, responses to user queries, and/or the like based on underlying resources. An example analytics computing system 102 is the SAP® Analytics Cloud available from SAP SE of Waldorf, Germany.

In some examples, the analytics computing system 102 is implemented in an on-premise environment. For example, an enterprise utilizing the analytics computing system may maintain an on-premise computing system. The analytics computing system 102 may be implemented by executing appropriate software at the on-premise computing system. Users 124, 126, 128 associated with the enterprise may access the analytics computing system 102 by accessing the on-premise computing system.

In some examples, the analytics computing system 102 is implemented in a cloud environment. For example, the analytics computing system 102 may be implemented in a public cloud environment or in a private cloud environment. In a private cloud environment, the enterprise may provide applications, implement storage, and the like, to implement the analytics computing system 102 at the private cloud environment. Executables and/or other software for implementing the analytics computing system 102 at the private cloud environment may be provided, for example, by a software provider. Users 124, 126, 128 of the enterprise may access the analytics computing system 102 at the private cloud environment, for example, to request, configure, and/or consume the analytics reports and/or other outputs of the analytics computing system 102.

In a public cloud environment, a cloud environment is arranged into a number of tenancies implemented by a cloud service provider. The cloud service provider may provide one or more executables or other components to implement the analytics computing system 102 at the public cloud environment. The enterprise may hold one or more tenancies, allowing users 124, 126, 128 of the enterprise to access one or more instances of the analytics computing system 102 at the public cloud environment to consume analytics reports, query responses, and/or other outputs of the analytics computing system 102.

The analytics computing system 102 may be in communication with various data sources 106, 108, 110. The data sources 106, 108, 110 may be or include various different computing systems and/or services for storing data. The data stored at the data sources 106, 108, 110 can be used by the analytics computing system 102 to generate various analytics outputs such as, reports, forecasts, responses to user queries, and/or the like, as described herein.

In some examples, data sources 106, 108, 110 may include cloud-delivered data source services and/or on-premise implemented data sources. For example, a cloud service provider may implement the cloud-delivered data source services in a public cloud environment. In some examples, one or more of the data sources 106, 108, 110 are implemented in a private cloud environment, for example, by the enterprise. Examples of cloud-delivered data source services may include cloud versions of S/4 HANA™, SAP Concur®, SAP Successfactors®, SAP Data Warehouse Cloud, Inbound Document (IBD), available from SAP SE of Waldorf, Germany. Other examples of cloud-delivered data sources may include SQL database services such as, for example, BigQuery® available from Google, LLC of Mountain View, California, Sharepoint® available from Microsoft Corporation of Redmond, Washington, various data storage products available from Salesforce, Inc. of San Francisco, California, and/or the like.

On-premise data sources may be implemented at one or more on-premise computing systems, which may be maintained by the consumer entity and/or another suitable entity. Examples of on-premise data sources may include on-premise versions of S/4 HANA™, SAP Business Warehouse, SAP Business Planning and Consolidation, SAP HANA™, various SQL, or other database management systems executed at an on-premise computing system and/or the like.

Data sources 106, 108, 110 may comprise data stored according to various formats. In some examples, one or more of the data sources 106, 108, 110 may include data stored in a matrix format according to tuples as described herein. In other examples, one or more of the data sources 106, 108, 110 may include data stored in other formats that may be converted to a matrix format according to tuples by the analytics computing system 102.

Users 124, 126, 128 may be associated with the enterprise utilizing the analytics computing system 102. The users 124, 126, 128 may access the analytics computing system 102 and/or one or more of the various data sources 106, 108, 110 utilizing user computing devices 130, 132, 134. User computing devices 130, 132, 134 may be or include various different types of computing devices such as, for example, desktop computers, laptop computers, tablet computers, mobile computing devices, and/or the like.

The analytics computing system 102 may also be in communication with a code repository 112. The code repository 112 may be implemented with the analytics computing system 102 and/or may be implemented as a data source similar to the data sources 106, 108, 110. In the example of FIG. 1, the code repository 112 comprises analytics code 114. The analytics code 114 may be executed at the analytics computing system 102 to implement a model of a process, system, and/or the like. The analytics code 114 may be implemented using tuple-based propositions, as described herein.

The analytics computing system 102 may include a runtime engine 104. The runtime engine 104 may be configured to execute analytics code 114 from the code repository 112. The runtime engine 104 may be configured to execute analytics code 114 in various forms. In some examples, some or all of the analytics code 114 is compiled object code. In some examples, the analytics code 114 is compiled object code arranged with strong-type variables. For example, variables used in the analytics code 114 may be declared with an explicit type such as, for example, string, integer, double, Boolean, and/or the like.

The analytics computing system 102 may also include an internal data store 138. The internal data store 138 may store query processing data 140 that may be acted on by the runtime engine 104 in accordance with the analytics code 114 as described herein. The query processing data 140 may be stored as tuple data items. In some examples, tuple data items represented by query processing data 140 may be stored in a matrix format so as to facilitate processing using the tuple-based proposition arrangement of the analytics code 114.

The internal data store 138 may be implemented using any data storage technology. In some examples, the internal data store 138 may include a database, a hard drive, and/or the like. Also, in some examples, although the internal data store 138 a shown as a component of the analytics computing system 102, it may be implemented as a data source similar to the data sources 106, 108, 110.

In some examples, analytics computing system 102 may be configured to respond to queries from users 124, 126, 128, such as query 120. The analytics computing system 102 may generate responses to the queries, such as response 122. The response to a query, such as response 122, may be provided to the user computing device 130, 132, 134 that originated the query 120. In some examples, the respective user computing devices 130, 132, 134 of the users 124, 126, 128 communicate with the analytics computing system 102 via an Application Programming Interface (API) 136. In some examples, the API 136 is implemented as a REpresentational State Transfer (REST) web service. Queries processed by the analytics computing system may include queries received directly from a user 124, 126, 128 and/or queries evaluated to prepare a report and/or other analysis.

The analytics code 114 may comprise various tuple-based propositions. Breakout window 115 shows two example tuple-based propositions 116, 118. The propositions 116, 118 comprise respective proposition head data 142, 146 and proposition body data 144, 148. The proposition head data 142, 146 indicates subject tuples for the respective propositions 116, 118. The proposition body data 144, 148 may describe at least one proposition condition for the respective propositions 116, 118. The at least one proposition condition for a respective proposition 116, 118 may comprise a relationship between one or more proposition body tuples and/or other variables. The at least one proposition condition for a respective proposition 116, 118 may be implied by the subject tuple. In some examples, one or more of the proposition body tuples may be subordinate subject tuples. A subordinate subject tuple is a proposition body tuple that is associated with its own proposition or propositions at the analytics code 114. The analytics computing system 102 may access the proposition data corresponding to any subordinate subject tuples and utilize that proposition data to evaluate a query.

Consider the following example proposition given by Code Fragment [2]:

(“costItem”, item, cost) :−((“produces”, supplier, item, cost), not ((“partOf”, item2, item))) [2]

In this example, the proposition head data includes a subject tuple having a predicate “costItem” and two arguments: “item” and “cost.” The subject tuple may sometimes also be referred to by the name of the predicate “costItem.” The proposition body comprises a first proposition body tuple having a predicate “produces” and three arguments: “supplier,” “item,” and “cost.” The second proposition body tuple has a predicate “partOf” and two arguments: “item2” and “item.” In this example, the at least one proposition condition is a conjunctive combination of the first proposition body tuple and the negation of the second proposition body tuple. In the Code Fragment [2], the proposition head and the proposition body are separated by the symbol “:−,” which indicates that the relationships described by the proposition body imply the truth of the proposition head. In this example, that (i) an item X is produced by a particular supplier Z at a cost Y; and that (ii) there is no item2 that is part of the item X implies that the item X has the cost Y.

The arguments of the subject tuple may act as input variables and/or output variables. For example, a query to the analytics computing system 102, such as the query 120, may indicate a subject tuple. The query may also include values for one or more of the arguments of the subject tuple. Consider again the proposition described by Code Fragment [2]. An example query that may be evaluated using the proposition is “how much does item X cost?.” Another example query that may be evaluated using the proposition is “which item or items have a cost of $10.” In some examples, a query may not indicate any of the arguments of the subject tuple. The analytics computing system 102 may respond to such a query by providing all available data for which the proposition conditions defined by the proposition body data are true.

The analytics computing system 102 may be programmed to respond to a query indicating a subject tuple by accessing query processing data associated with the various proposition body tuples of the corresponding proposition. The query processing data may be expressed, for example, at the internal data store 138 of the analytics computing system 102 as tuple data items in a matrix format. The analytics computing system 102 (e.g., the runtime engine 104 thereof) may select a subset of the query processing data for which the proposition condition or conditions defined by the proposition body data are true. In some examples, the runtime engine 104 may select the subset of the query processing data by performing matrix-based operations on the query processing data for the respective proposition body tuples. The subset of the query processing data may be used to generate a query response, such as the query response 122, that may be provided to the requesting user 124, 126, 128, via that user's computing device 130, 132, 134.

Consider an example query indicating the subject tuple “costItem” described by Code Fragment [2] above. To evaluate the query, the analytics computing system 102 may access proposition data corresponding to the subject tuple, which may be given by Code Fragment [2]. The analytics computing system 102 may further access query processing data for the proposition body tuples indicated by the proposition. In the example given by Code Fragment [2], the analytics computing system may access query processing data for the proposition body tuple “produces” and query processing data for the proposition body tuple “part of.”

The query processing data may be arranged in a matrix format. For example, a matrix format may include tuple data items arranged in a row and column format in which columns correspond to the arguments of a tuple and rows correspond to different tuple data items. Consider example TABLE 1 below, which shows example matrix-formatted query processing data for the proposition body tuple “produces:”

TABLE 1

| PRODUCES | | | |
|---|---|---|---|
| Supplier | Item | Cost | Check |
| Acme Motor Co. | CarModel | 20000 | True |
| ABC Co. | Battery pack | 5000 | True |
| XYZ, Ltc. | lithium | 1000 | True |

In TABLE 1, a first column corresponds to the argument “supplier,” a second column corresponds to the argument “item,” and a third column corresponds to the argument “cost.” Each row corresponds to a tuple data item that is an example of the tuple “produces.” TABLE 1 includes an additional column labeled “check.” This column may be included to indicate whether the data items in the various rows are valid and exist. For example, data items that are not consistent with rules defining the relevant tuples may include a value of “false” in the “check” column. In the example of TABLE 1, each of the example data items is complete, so the “check” column value for each row is equal to true. In some examples, a tuple data item that is missing a value for one or more of the arguments may have a value in the check column indicating false.

TABLE 2 shows example matrix-formatted query processing data for the proposition body tuple “partOf:”

TABLE 2

| PART OF | | |
|---|---|---|
| Item | Is Part Of | Check |
| Battery pack | CarModel | True |
| Lithium | Battery pack | True |

As with TABLE 1, TABLE 2 includes columns corresponding to the arguments of the tuple “partOf.” In this example, a first column corresponds to the argument “item” and a second column corresponds to the argument “item2.” The rows of TABLE 2 indicate tuple data items.

The analytics computing system 102 may be configured to respond to various different types of queries indicating the subject tuple “costItem” including queries that indicate values for some, all, or none of the arguments of the subject tuple. A first example query may include the value “lithium” for the subject tuple argument “item.” The analytics computing system 102 may respond to the first example query by returning one or more values of the subject tuple argument “cost” that are consistent with the proposition conditions described by the proposition body. The analytics computing system 102 may determine a subset of the query processing data given by TABLE 1 and TABLE 2 that meets the proposition condition given by the proposition of Code Fragment [2]. This may include performing a matrix-based operation that identifies a row of TABLE 1 including a tuple data item having the value “lithium” for “item” that is also not indicated as an “item” in any row of TABLE 2. In the example above, this corresponds to a cost of “1000,” as given at TABLE 1.

A second example query may include the value “1000” for the subject tuple argument “cost.” The analytics computing system 102 may respond to the first example query by returning one or more values of the argument “item” that are consistent with the proposition conditions described by the proposition body. The analytics computing system 102 may determine a subset of the query processing data given by TABLE 1 and TABLE 2 that meets the proposition condition given by the proposition body data, here shown at Code Fragment [2]. This may include performing a matrix-based operation that identifies a row or rows of TABLE 1 including a tuple data item or items having the value “1000” for “cost.” In this example, the identified row or rows may also indicate a value for the argument “item” at TABLE 1 only if that value for the argument “item” that is not indicated as part of a tuple data item in any row of TABLE 2.

A third example query may include an indication of the subject tuple “costItem” but may not include any values for arguments. In this example, the analytics computing system 102 may perform a matrix-based operation that identifies rows at TABLE 1 indicating a value for the argument “item” that is not indicated as a value for the argument “item” in any tuple data item of TABLE 2. In this example, the analytics computing system 102 may return a query response indicating the item “lithium” and the cost “1000.”

In some examples, a subject tuple may correspond to more than one proposition at the analytics code 114. In examples in which a subject tuple corresponds to more than one proposition, the analytics computing system 102 may evaluate both propositions and joined them disjunctively. Consider an additional example proposition for the subject tuple “costItem” given by Code Fragment [3] below:

(“costItem”, item, costTot) :−((“produces”, partner, item, cost), (“partOf”, item2, item), (“costDelivery”, item2, partner, deliveryCost), //recursive call (“costItem”, item2, cost2),//recursive call costTot:=cost+cost2+deliveryCost) [3]

In the example provided by the combination of Code Fragments [2] and [3], the subject tuple “costItem” corresponds to both the proposition given by Code Fragment [2] and the proposition given by Code Fragment [3]. Accordingly, the analytics computing system 102, upon receiving a query indicating the subject tuple “costItem” may evaluate both propositions and join the results disjunctively, by applying a logical OR as described herein. Consider again the example query above indicating the subject tuple “costItem” and the value “lithium” for the argument “item.” In this example, the query processing data for the proposition body tuple “partOf” given by TABLE 2 may not include any tuple data items having the value “lithium” for the argument “item.” Accordingly, in this example, the proposition given by Code Fragment [2] may return the value for “cost” as described above while the proposition given by Code Fragment [3] may return null. A disjunctive combination of “1000” and null may yield “1000.” Accordingly, the analytics computing system 102 may return “1000” as the value for the subject tuple argument “cost.”

The example proposition given by Code Fragment [3] also illustrates an example recursive subject tuple. For example, the proposition body tuples given in Code Fragment [3] for the subject tuple “costItem” include “produces,” “part of,” “costDelivery,” and “costItem,” where “costItem” is also the subject tuple. In this example, the analytics computing system 102 may recursively determine the item cost for each constituent item until encountering an item producing an item cost with the proposition given by Code Fragment [3], which does not include a recursive call.

Consider an example tuple-based proposition for the subject tuple “costDelivery” given by Code Fragment [4] below:

(“costDelivery”, item, consumer, deliveryCost) :−((“produces”, supplier, item), (“locatedAt”, consumer, loc1), (“locatedAt”, supplier, loc2), (“deliveryCost”, loc2, loc1, deliveryCost)) [4]

Consider also matrix-formatted example query processing data for the proposition body tuples “locatedAt” and “deliveryCost” given by TABLES 3 and 4 below:

TABLE 3

| LOCATED AT | | |
|---|---|---|
| Entity | Location | Check |
| Acme Motor Co. | Munich | True |
| ABC Co. | Shenzen | True |
| XYZ, Ltd. | Chile | True |

TABLE 4

| DELIVERY COST | | | |
|---|---|---|---|
| Source | Destination | Cost | Check |
| Chile | Shenzen | 100 | True |
| Shenzen | Munich | 90 | True |

In some examples, the analytics code 114 may include support for various logical operations such as, for example, OR, AND, and JOIN. Various AND, OR, and JOIN logical statements can be executed by the analytics computing system 102 using matrix operations, for example, as described herein.

One example utilizing a logical OR is the “costItem” proposition given by Code Fragments [2] and [3]. In another example utilizing a logical OR is given by the following example Expressions [5] and [6]:

p(x,y):−(x %2)==0,y:=x*10 [5]

p(x,y):−(x %2)!=0,y:=x*100 [6]

The predicate p (x, y) given by expressions [5] and [6] may be expressed as “if x is divisible by two, then y=x*10, otherwise y=x*100.” Consider an example in which the predicate p (x, y) is applied to data d1 given by TABLE 5 below:

TABLE 5

| d1 | | |
|---|---|---|
| x | y | Check |
| 2 | | True |
| 3 | | True |

The result of applying the predicate p (x, y) to the data d1 may be given by TABLE 6 below, which includes data d2:

TABLE 6

| d2 | | |
|---|---|---|
| X | y | Check |
| 2 | 20 | True |
| 3 | 300 | True |

Accordingly, the application of an OR logical operation in analytics code 114 may involve combining occurrences of the predicate into a single answer, represented in this example, by a single table.

Consider another example application of an OR logical operation to two data sets d3, d4 given by TABLES [7] and [8] below. In the data sets d3 and d4 various entries include null values:

TABLE 7

| d3 | | |
|---|---|---|
| X | y | Check |
| 2 | 20 | True |
| 3 | | False |

TABLE 8

| d4 | | |
|---|---|---|
| X | y | Check |
| 2 | | False |
| 3 | 300 | True |

The result of applying a logical OR operation to data d3 and d4 may be as given in TABLE 6 above. For example, the rows may be modified in a way such that rows representing a subset of rows from the other matrix are removed from the results. For example, the row x=3, y=null from d4 will be replaced by all rows in d4 that have x=3. Conversely, if one were to apply a logical AND operation two d3 and d4, the result would be an empty set there are no rows matching both answers.

An example of an AND operation implemented in the analytics code 114 is in the body of a proposition. For example, elements separated by an “,” may be processed with a logical AND operation. Consider the example proposition for “costItem” given by Code Fragment [2] above. Each of the tuples expressed in the proposition body may be combined using a logical AND operation to obtain the result.

Another example using a logical AND is given by Expression [7] below:

q(x,y):−p(x,y),r(x,y) [7]

In this example, the predicate r (x, y) returns false for any value of x that is not divisible by two. For an example application of the predicate q(x,y) to the data d1 given by TABLE 5 above, the result of the predicate p(x,y) would be the same as that above, given by TABLE 6. The result of the predicate r (x, y) would be given by d3 as shown by TABLE 9 below:

TABLE 9

| d3 | | |
|---|---|---|
| X | y | Check |
| 2 | 20 | True |
| 3 | 300 | False |

The predicate p(x,y), given by Expression [7] may be found by applying the logical AND operation between the data d2 and the data d1. The result may be given by data d4 in TABLE 10 below:

TABLE 10

| d4 | | |
|---|---|---|
| X | y | Check |
| 2 | 20 | True |
| 3 | | False |

A JOIN logical operation may be similar to an AND operation, but among proposition body elements that do not have the same set of variables, but rather have common intersections of variables. An example is given by Expression [8] below:

r(x,y):−w(x,z),k(z,y) [8]

In this example, since the intersection among the predicates w and k is the variable z, then a join of the two predicates would be a matrix x, y, z, albeit omitting the column z.

The analytics computing system 102 may be programmed to execute analytics code 114 by applying various different matrix-based algorithms to determine the subsets of query processing data for which the body proposition data of a proposition is true. One example matrix algorithm is a blender algorithm. A blender algorithm may take two matrices α, and b, such as, for example any two of the matrices given by the examples in TABLES 1-4. In some examples, the input matrices to the blender algorithm may have the same number of columns. The blender algorithm may take one column at a time from the input matrices, sort the entries in the column, and then execute a merger that combines pair wise values for all of the columns of the matrices. The blender algorithm may return a list of tuple data items composed of two terms. The first term may be the index of a row from the matrix α. The second term may be the index of a row from the matrix b.

Consider an example matrix α given by Expression [9] and TABLE 11 and an example matrix b given by Expression [10] and TABLE 12:

a=Matrix((x,y),(1,10)) [9]

TABLE 11

| x | y | check |
|---|---|---|
| 1 | 10 | TRUE |

b=Matrix((x,y),(1,10),(2,20)) [10]

TABLE 12

| x | y | Check |
|---|---|---|
| 1 | 10 | TRUE |
| 2 | 20 | TRUE |

In this example, applying the blender algorithm to the example matrices α and b will result in the Expression [11]:

Blender(a,b)=Map(0,0)→Array(1,10)) [11]

This means that the row in the matrix α having an index of zero and the row in b having an index of zero will be blended as (1, 10). This may result in a map with a key being the tuple of the row index in the first matrix α and the second matrix b. The value of the map may be a blended row from both matrices α, b. In the example above, the second row of matrix b does not have any corresponding row in the matrix α.

Another example matrix-based algorithm that may be used to determine subsets of query processing data as described herein is a merger algorithm. A merger algorithm may take as input two matrices α and b and an indication of one or more row pairs from the two matrices. The merger algorithm may return a merged matrix determined from the two input matrices.

One example of a merger algorithm is an OR merger. An OR merger may generate a merged matrix by taking all of the matching rows from a and b and appending them together, for example, using an OR logical operation as described herein. The check variable is computed on each row according to an indicated policy. For example, if at least one of the rows has a check value indicating true, then the check value for the corresponding row at the merged matrix may also be true. Otherwise, the check value for the corresponding row with the merged matrix may be false.

Another example of a merger algorithm is an AND merger. An AND merger may create the merged matrix out of all of the indicated rows from matrices α and b, for example, using an AND logical operation, as described herein. Yet another example of a merger algorithm is a join merger. According to a join merger, the merged matrix is a union of the column variables from the indicated rows of input matrices α and b. In some examples, the check value for rows in the merged matrix is true if both of the constituent rows from the input matrices α and b had check values equal to true and false otherwise.

Consider an example application of an AND merger given by Expression [12] below:

andMerger (a, Map ((0,0)→Array (1, 10)),b) [12]

The result of Expression [8] is given by TABLE 13:

TABLE 13

| x | y | Check |
|---|---|---|
| 1 | 10 | TRUE |
| 2 | 20 | FALSE |

An example application of and OR merger applied to the example matrices α and b above is given by Expression [13]:

orMerger (a, Map ((0,0)→Array (1, 10)),b) [13]

The result of Expression [13] is given by TABLE 14:

TABLE 14

| x | y | Check |
|---|---|---|
| 1 | 10 | TRUE |
| 2 | 20 | TRUE |

An additional matrix-based algorithm that may be used to determine subsets of query processing data is a combiner algorithm. A combiner algorithm receives two input matrices α and b and returns a combined matrix. A combiner algorithm may be used, for example, when a subject tuple corresponds to more than one proposition. In this scenario, a combiner algorithm may be applied to the matrices returned by the various propositions.

An OR combiner algorithm may return a combined matrix as given by Code Fragment [14]:

(a, b)=>OrMerger(a, b, Blender(a, b, (valueA, valueB)=>if valueA==null then valueA else valueB)) [14]

An AND combiner algorithm may return a combined matrix as given by Code Fragment [15]:

(a, b)=>AndMerger(a, b, Blender(a, b, (valueA, valueB)=>if valueA==null then valueB else valueA)) [15]

for AND combiner algorithm applications and OR combiner algorithm applications, the “AND” or “OR” nature of the algorithm application may be invoked transparently based on the nature of the underlying merger, as shown by Code Fragments [14] and [15]. A Join Combiner may join matrices that have at least one variable in common. For example, a join combiner may return a combined matrix as given by Code Fragment [16]:

(a, b)=>AndMerger(a, b, Blender(a, b, (valueA, valueB)=>valueA)) [16]

A NOT combiner algorithm may be similar to a joint combiner, but may switch the values of the check column in the resulting combined matrix. For example, a not combiner algorithm may return a combined matrix as given by Code Fragment [17]:

(a, b)=>AndMerger(a, b, Blender(a, b, (valueA, valueB)=>valueA)) [17]

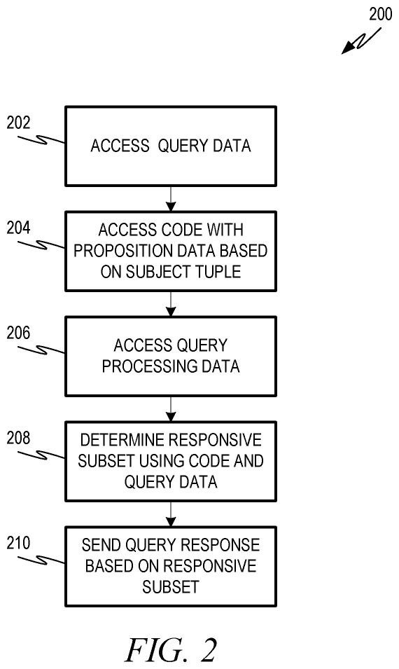

FIG. 2 is a flowchart showing one example of a process flow 200 that may be executed in the environment 100 by the analytics computing system 102 to respond to a query using tuple-based propositions. At operation 202, the analytics computing system 102 may access query data. The query data may have been received from a user computing device 130, 130, 132 associated with the user 124, 126, 128. The query data may be indicative of a standalone query from a user 124, 126, 128. In various examples, the query data may be evaluated as a constituent operation as part of generating a report or other output of the analytics computing system 102. The query data may indicate a subject tuple and, in some examples, may indicate as input variables a value or values for one or more arguments of the subject tuple.

At operation 204, the analytics computing system 102 may access analytics code 114 including proposition data describing one or more propositions associated with the subject tuple. The one or more propositions may describe respective proposition conditions which may include, for example, relationships between one or more body proposition tuples and/or other variables. In some examples, a subject tuple may correspond to more than one proposition at the analytics code 114. When this occurs, the analytics computing system 102 may access analytics code corresponding to all propositions that apply to the subject tuple. Also, in some examples, one or more of the propositions corresponding to the subject tuple may indicate subordinate subject tuples. The analytics computing system 102 may also access analytics code 114 for any subordinate subject tuples. An example of a subordinate subject tuple is shown at Code Fragment [3] where the subject tuple “costItem” is associated with a subordinate subject tuple “costDelivery.”

At operation 206, the analytics computing system 102 may access query processing data. As described herein, query processing data may be obtained for each proposition body tuple described by the at least one of the propositions accessed at operation 204. The query processing data may be retrieved from one or more of the data sources 106, 108, 110 and stored at internal data store 138 for processing (e.g., by the runtime engine 104). The query processing data may be stored at the internal data store 138 in a matrix format, as described herein.

At operation 208, the analytics computing system 102 may determine a subset of the query processing data for which the proposition conditions indicated by the propositions accessed at operation 204 is true. At operation 210, the analytics computing system 102 may send a query response to the requesting user computing device 130, 132, 134. The query response may be based on the subset of the query processing data identified at operation 208.

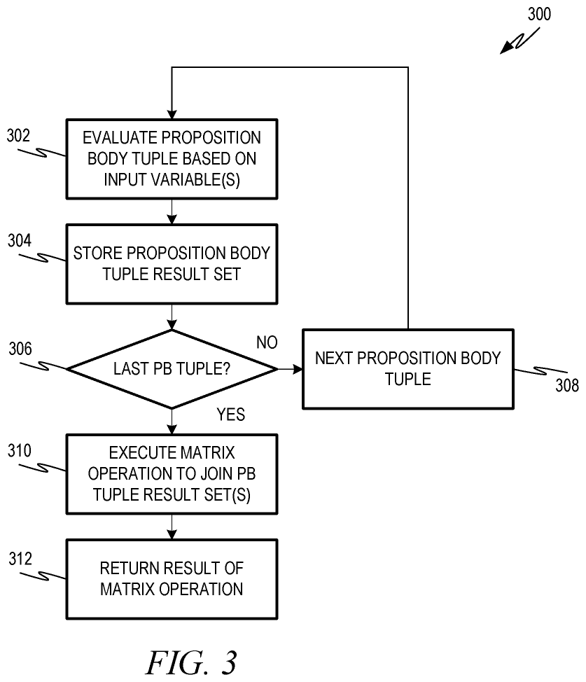

FIG. 3 is a flowchart showing one example of a process flow 300 that may be executed by the analytics computing system (e.g., the runtime engine 104 thereof) to evaluate a received query. For example, the process flow 300 shows one example way to execute operation 208 of the process flow 200.

At operation 302, the analytics computing system 102 may evaluate a first proposition body tuple, optionally based on one or more input variables corresponding to one or more of the arguments of the subject tuple. This may include identifying a set of one or more tuple data items from the query processing data associated with the first proposition body tuple that are consistent with one or more input variables. The input variables may be determined based on the query and/or by the evaluation of a prior proposition body tuple. The analytics computing system 102 may store the set of one or more tuple data items, which may be referred to as a tuple results set, at operation 304. In some examples, the tuple results set may be stored to the internal data store 138 of the analytics computing system 102.

At operation 306, the analytics computing system 102 may determine if the current proposition body tuple is the last proposition body tuple in the proposition body to be evaluated. If the current proposition body tuple is not the last proposition body tuple to be evaluated, then the analytics computing system 102 may increment to the next proposition body tuple at operation 308 and return to operation 302 to evaluate at proposition body tuple. If the current proposition body tuple is the last proposition body tuple at operation 306, then the analytics computing system 102 may, at operation 310, execute a matrix operation two join from the various proposition body tuples of the proposition body. In some examples, this may include executing a matrix-based algorithm such as a blender algorithm and/or a combiner algorithm, as described herein. At operation 312, the analytics computing system 102 may return a result of the matrix operation. For example, the result of the matrix operation may be the subset of the query processing data for which the one or more proposition conditions are true.

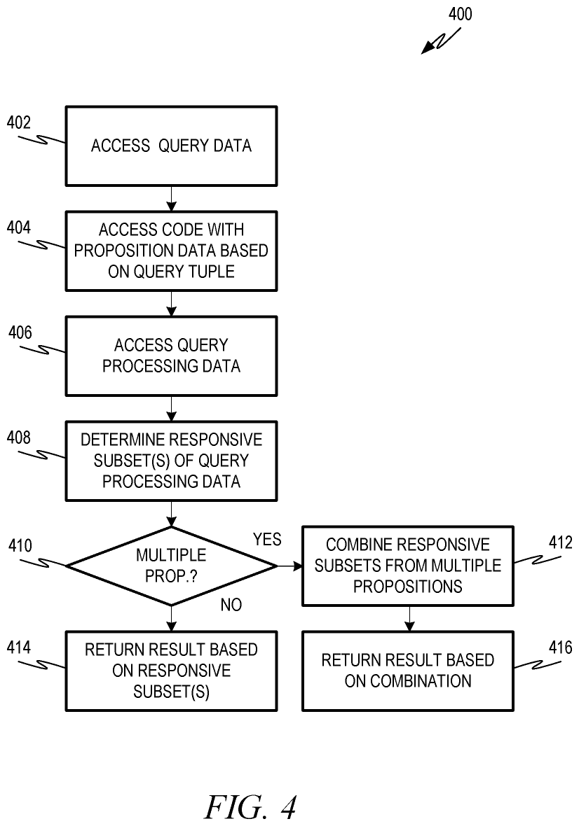

FIG. 4 is a flowchart showing another example of a process flow 400 that may be executed by the analytics computing system 102 to evaluate a query using tuple-based propositions. At operation 402, the analytics computing system 102 may access query data. The query data may have been received from a user computing device 130, 130, 132 associated with the user 124, 126, 128. The query data may indicate a subject tuple and, in some examples, may indicate as input variables a value or values for one or more arguments of the subject tuple.

At operation 404, the analytics computing system 102 may access analytics code 114 including proposition data describing at least one proposition associated with the subject tuple. At operation 406, the analytics computing system 102 may access query processing data for the proposition body tuples of the one or more propositions accessed at operation 404, including any subordinate subject tuples.

At operation 408, the analytics computing system 102 may determine responsive subsets of the query processing data for each of the propositions corresponding to the subject tuple. At operation 410, the analytics computing system 102 may determine if the subject tuple corresponded to more than one proposition at the analytics code 114. If the subject tuple did not correspond to more than one proposition, then the analytics computing system 102 may, at operation 414, return the responsive subset identified at operation 408. If the subject tuple did correspond to more than one proposition, then the analytics computing system 102 may, at operation 412, disjunctively combine the responsive subset or subsets from the multiple propositions corresponding to the subject tuple. In some examples, the combination may be performed using a combiner algorithm as described herein. The analytics computing system 102 may return a result of the query based on the combination at operation 416.

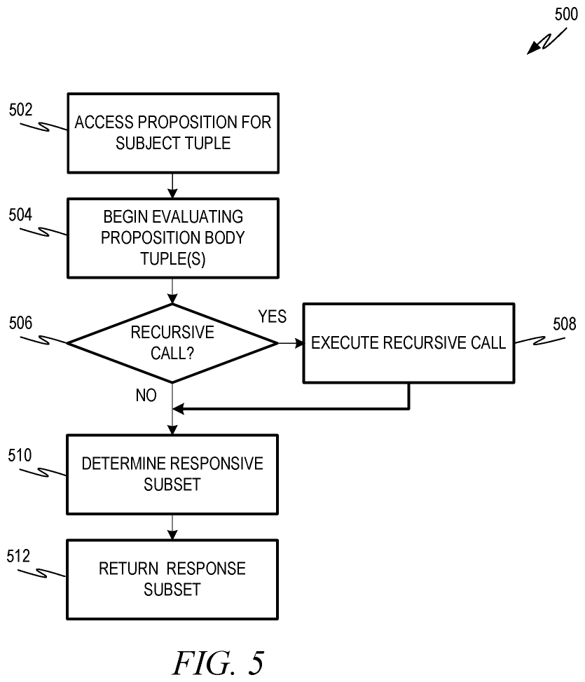

FIG. 5 is a flowchart showing one example of process flow 500 that may be executed by the analytics computing system 102 to evaluate a proposition including a recursive call. At operation 502, the analytics computing system 102 may access analytics code 114 describing a proposition corresponding to a subject tuple of a query. At operation 504, the analytics computing system 102 may begin evaluating proposition body tuples of the proposition accessed at operation 502. At operation 506, the analytics computing system 102 may determine if any of the proposition body tuples is a recursive tuple. A recursive tuple, for example, may be a proposition body tuple that is the subject tuple. If one of the proposition body tuples is the subject tuple and, therefore, is a recursive tuple, then the analytics computing system 102 may execute a recursive call to the subject tuple at operation 508. Executing a recursive call may include reevaluating the proposition for the subject tuple, for example, using at least one input variable determined from one of the other proposition body tuples evaluated at operation 504. The recursive call, when complete, may return a result.

If no recursive call is detected at operation 506, and/or after receiving the result of a recursive call executed at operation 508, the analytics computing system 102 may determine a responsive subset of the query processing data for the proposition at operation 510. If a recursive call was made at operation 508, then the analytics computing system 102 may consider a result of the recursive call when determining the responsive subset. At operation 512, the analytics computing system 102 may return the responsive subset. In some examples, the responsive subset may be returned as part of a query response. In other examples, the responsive subset may be returned for use in evaluating a higher-level proposition.

### EXAMPLES

Example 1 is an analytics computing system, comprising: at least one processor programmed to perform operations comprising: receiving query data describing a query, the query data comprising an indication of a subject tuple; accessing analytics code, the analytics code comprising first proposition data corresponding to the subject tuple, the first proposition data comprising: proposition head data describing the subject tuple; and proposition body data describing at least one proposition condition, the at least one proposition condition comprising a relationship between a first proposition body tuple and a second proposition body tuple; accessing query processing data, the query processing data comprising data associated with the first proposition body tuple and data associated with the second proposition body tuple; determining a subset of the query processing data for which the at least one proposition condition is true; and sending query response data, the query response data being based on the subset of the query processing data for which the at least one proposition condition is true.

In Example 2, the subject matter of Example 1 optionally includes the query data further comprising a value for a first argument of the subject tuple, the subset of the data for which the at least one proposition condition is true comprising a value for a second argument of the subject tuple.

In Example 3, the subject matter of Example 2 optionally includes the operations further comprising: receiving second query data describing a second query, the second query data comprising an indication of the subject tuple and a second value for the second argument of the subject tuple; determining a second subset of the query processing data for which the at least one proposition condition is true, the second subset of the query processing data also being based at least in part on the second value for the second argument of the subject tuple; and sending second query response data, the second query response data being based at least in part on the second subset of the query processing data for which the at least one proposition condition is true, and the second query response data comprising a second value for the first argument of the subject tuple.

In Example 4, the subject matter of any one or more of Examples 1-3 optionally include the subset of the data for which the at least one proposition condition is true comprising a plurality of values for a first argument of the subject tuple and a plurality of values for a second argument of the subject tuple.

In Example 5, the subject matter of any one or more of Examples 1-4 optionally include the first proposition body tuple being represented at the analytics computing system as a first proposition matrix, the second proposition body tuple being represented at the analytics computing system as a second proposition matrix, and the determining of the subset of query processing data for which the at least one proposition is true comprising executing a matrix operation using the first proposition matrix and the second proposition matrix.

In Example 6, the subject matter of any one or more of Examples 1-5 optionally include the proposition body data further describing the subject tuple, the determining of the subset of query processing data for which the at least one proposition condition is true comprising: evaluating the first proposition body tuple; and evaluating the subject tuple recursively based at least in part on the evaluation of the first proposition body tuple.

In Example 7, the subject matter of any one or more of Examples 1-6 optionally include the accessing of the analytics code further comprising: accessing second proposition data that also corresponds to the subject tuple, the second proposition data comprising second proposition head data describing the subject tuple and second proposition body data describing at least one second proposition condition; accessing second query processing data, the second query processing data being based at least in part on the second proposition body data; and determining a subset of the second query processing data for which the at least one second proposition condition is true, the query response data also being based on the subset of the second query processing data for which the at least one second proposition condition is true.

In Example 8, the subject matter of any one or more of Examples 1-7 optionally include the relationship between the first proposition body tuple and the second proposition body tuple indicating a conjunction between the first proposition body tuple and the second proposition body tuple.

In Example 9, the subject matter of any one or more of Examples 1-8 optionally include the analytics code further comprising at least one operation using at least one argument of the first proposition body tuple and at least one argument of the second proposition body tuple, the operations further comprising using the subset of query processing data for which the at least one proposition condition is true, and evaluating the at least one operation, the query response data also being based at least in part on a result of the evaluating of the at least one operation.

Example 10 is a method, comprising: receiving, by an analytics computing system and from a computing device, query data describing a query, the query data comprising an indication of a subject tuple; accessing analytics code, by the analytics computing system, the analytics code comprising first proposition data corresponding to the subject tuple, the first proposition data comprising: proposition head data describing the subject tuple; and proposition body data describing at least one proposition condition, the at least one proposition condition comprising a relationship between a first proposition body tuple and a second proposition body tuple; accessing, by the analytics computing system, query processing data, the query processing data comprising data associated with the first proposition body tuple and data associated with the second proposition body tuple; determining, by the analytics computing system, a subset of the query processing data for which the at least one proposition condition is true; and sending, by the analytics computing system and to the computing device, query response data, the query response data being based on the subset of the query processing data for which the at least one proposition condition is true.

In Example 11, the subject matter of Example 10 optionally includes the query data further comprising a value for a first argument of the subject tuple, the subset of the data for which the at least one proposition condition is true comprising a value for a second argument of the subject tuple.

In Example 12, the subject matter of Example 11 optionally includes receiving, by the analytics computing system, second query data describing a second query, the second query data comprising an indication of the subject tuple and a second value for the second argument of the subject tuple; determining, by the analytics computing system, a second subset of the query processing data for which the at least one proposition condition is true, the second subset of the query processing data also being based at least in part on the second value for the second argument of the subject tuple; and sending, by the analytics computing system, second query response data, the second query response data being based at least in part on the second subset of the query processing data for which the at least one proposition condition is true, and the second query response data comprising a second value for the first argument of the subject tuple.

In Example 13, the subject matter of any one or more of Examples 10-12 optionally include the subset of the data for which the at least one proposition condition is true comprising a plurality of values for a first argument of the subject tuple and a plurality of values for a second argument of the subject tuple.

In Example 14, the subject matter of any one or more of Examples 10-13 optionally include the first proposition body tuple being represented at the analytics computing system as a first proposition matrix, the second proposition body tuple being represented at the analytics computing system as a second proposition matrix, and the determining of the subset of query processing data for which the at least one proposition is true comprising executing a matrix operation using the first proposition matrix and the second proposition matrix.

In Example 15, the subject matter of any one or more of Examples 10-14 optionally include the proposition body data further describing the subject tuple, the determining of the subset of query processing data for which the at least one proposition condition is true comprising: evaluating the first proposition body tuple; and evaluating the subject tuple recursively based at least in part on the evaluation of the first proposition body tuple.

In Example 16, the subject matter of any one or more of Examples 10-15 optionally include the accessing of the analytics code further comprising: accessing second proposition data that also corresponds to the subject tuple; the second proposition data comprising second proposition head data describing the subject tuple and second proposition body data describing at least one second proposition condition; accessing second query processing data, the second query processing data being based at least in part on the second proposition body data; and determining a subset of the second query processing data for which the at least one second proposition condition is true, the query response data also being based on the subset of the second query processing data for which the at least one second proposition condition is true.

In Example 17, the subject matter of any one or more of Examples 10-16 optionally include the relationship between the first proposition body tuple and the second proposition body tuple indicating a conjunction between the first proposition body tuple and the second proposition body tuple.

In Example 18, the subject matter of any one or more of Examples 10-17 optionally include the analytics code further comprising at least one operation using at least one argument of the first proposition body tuple and at least one argument of the second proposition body tuple, the method further comprising using the subset of query processing data for which the at least one proposition condition is true, evaluating the at least one operation, the query response data also being based at least in part on a result of the evaluating of the at least one operation.

Example 19 is anon-transitory machine-readable medium comprising instructions thereon that, when executed by at least one processor, cause the at least one processor to perform operations comprising: receiving query data describing a query, the query data comprising an indication of a subject tuple; accessing analytics code, the analytics code comprising first proposition data corresponding to the subject tuple, the first proposition data comprising: proposition head data describing the subject tuple; and proposition body data describing at least one proposition condition, the at least one proposition condition comprising a relationship between a first proposition body tuple and a second proposition body tuple; accessing query processing data, the query processing data comprising data associated with the first proposition body tuple and data associated with the second proposition body tuple; determining a subset of the query processing data for which the at least one proposition condition is true; and sending query response data, the query response data being based on the subset of the query processing data for which the at least one proposition condition is true.

In Example 20, the subject matter of Example 19 optionally includes the query data further comprising a value for a first argument of the subject tuple, the subset of the data for which the at least one proposition condition is true comprising a value for a second argument of the subject tuple.

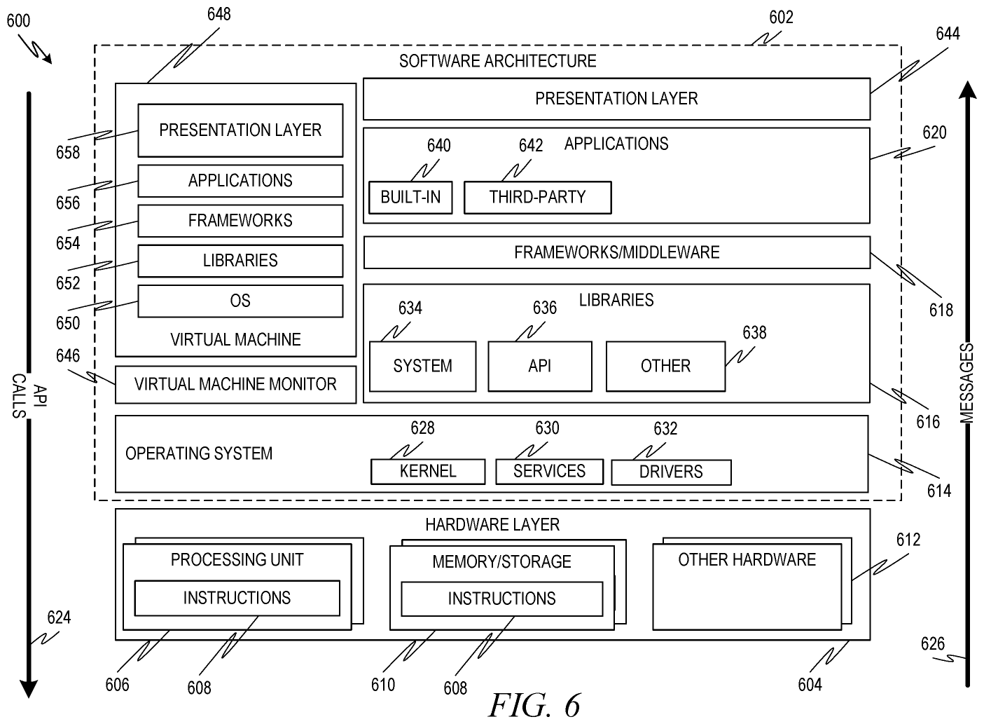

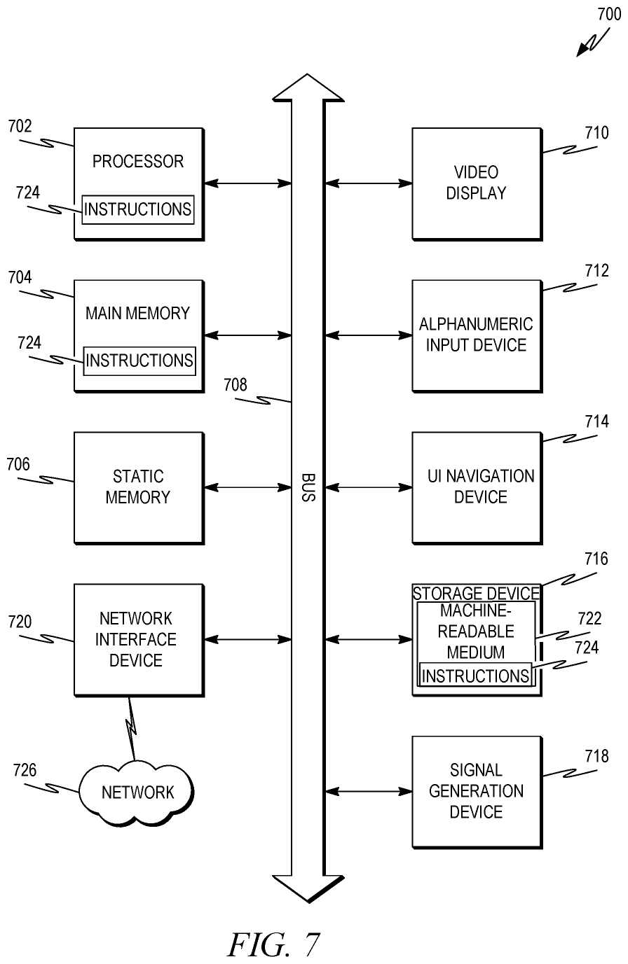

FIG. 6 is a block diagram 600 showing one example of a software architecture 602 for a computing device. The architecture 602 may be used in conjunction with various hardware architectures, for example, as described herein. FIG. 6 is merely a non-limiting example of a software architecture and many other architectures may be implemented to facilitate the functionality described herein. A representative hardware layer 604 is illustrated and can represent, for example, any of the above referenced computing devices. In some examples, the hardware layer 604 may be implemented according to the architecture of the computer system of FIG. 7.

The representative hardware layer 604 comprises one or more processing units 606 having associated executable instructions 608. Executable instructions 608 represent the executable instructions of the software architecture 602, including implementation of the methods, modules, subsystems, and components, and so forth described herein and may also include memory and/or storage modules 610, which also have executable instructions 608. Hardware layer 604 may also comprise other hardware as indicated by other hardware 612 which represents any other hardware of the hardware layer 604, such as the other hardware illustrated as part of the architecture 602.

In the example architecture of FIG. 6, the software architecture 602 may be conceptualized as a stack of layers where each layer provides particular functionality. For example, the software architecture 602 may include layers such as an operating system 614, libraries 616, middleware layer 618, applications 620, and presentation layer 644. Operationally, the applications 620 and/or other components within the layers may invoke API calls 624 through the software stack and access a response, returned values, and so forth illustrated as messages 626 in response to the API calls 624. The layers illustrated are representative in nature and not all software architectures have all layers. For example, some mobile or special purpose operating systems may not provide a middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. In some examples, the services 630 include an interrupt service. The interrupt service may detect the receipt of an interrupt and, in response, cause the architecture 602 to pause its current processing and execute an interrupt service routine (ISR) when an interrupt is accessed.

The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The middleware layer 618 (also sometimes referred to as frameworks) may provide a higher-level common infrastructure that may be utilized by the applications 620 and/or other software components/modules. For example, the middleware layer 618 may provide various graphic user interface (GUI) functions, high-level resource management, high-level location services, and so forth. The middleware layer 618 may provide a broad spectrum of other APIs that may be utilized by the applications 620 and/or other software components/modules, some of which may be specific to a particular operating system or platform.

The applications 620 includes built-in applications 640 and/or third-party applications 642. Examples of representative built-in applications 640 may include, but are not limited to, a contacts application, a browser application, a book reader application, a location application, a media application, a messaging application, and/or a game application. Third-party applications 642 may include any of the built-in applications 640 as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 642 may invoke the API calls 624 provided by the mobile operating system such as operating system 614 to facilitate functionality described herein.

The applications 620 may utilize built-in operating system functions (e.g., kernel 628, services 630 and/or drivers 632), libraries (e.g., system 634, API libraries 636, and other libraries 638), and middleware layer 618 to create user interfaces to interact with users of the system. Alternatively, or additionally, in some systems, interactions with a user may occur through a presentation layer, such as presentation layer 644. In these systems, the application/module “logic” can be separated from the aspects of the application/module that interact with a user.

Some software architectures utilize virtual machines. In the example of FIG. 6, this is illustrated by virtual machine 648. A virtual machine creates a software environment where applications/modules can execute as if they were executing on a hardware computing device. A virtual machine is hosted by a host operating system (operating system 614) and typically, although not always, has a virtual machine monitor 646, which manages the operation of the virtual machine as well as the interface with the host operating system (i.e., operating system 614). A software architecture executes within the virtual machine such as an operating system 650, libraries 652, frameworks/middleware 654, applications 656 and/or presentation layer 658. These layers of software architecture executing within the virtual machine 648 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 7 is a block diagram of a machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation (or cursor control) device 714 (e.g., a mouse), a disk drive unit 716, a signal generation device 718 (e.g., a speaker), and a network interface device 720.

### Machine-Readable Medium

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media 722.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. The term “machine-readable medium” shall accordingly be taken to include, but not be limited to, solid-state memories, and optical and magnetic media. Specific examples of machine-readable media 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 724 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An analytics computing system, comprising:
at least one processor programmed to perform operations comprising:
receiving query data describing a query, the query data comprising an indication of a subject tuple;
accessing analytics code, the analytics code comprising first proposition data corresponding to the subject tuple, the first proposition data comprising:
proposition head data describing the subject tuple; and
proposition body data describing at least one proposition condition, the at least one proposition condition comprising a relationship between a first proposition body tuple and a second proposition body tuple;
accessing query processing data, the query processing data comprising data associated with the first proposition body tuple and data associated with the second proposition body tuple;
determining a subset of the query processing data for which the at least one proposition condition is true; and
sending query response data, the query response data being based on the subset of the query processing data for which the at least one proposition condition is true.

2. The system of claim 1, the query data further comprising a value for a first argument of the subject tuple, the subset of the data for which the at least one proposition condition is true comprising a value for a second argument of the subject tuple.

3. The system of claim 2, the operations further comprising:
receiving second query data describing a second query, the second query data comprising an indication of the subject tuple and a second value for the second argument of the subject tuple;
determining a second subset of the query processing data for which the at least one proposition condition is true, the second subset of the query processing data also being based at least in part on the second value for the second argument of the subject tuple; and
sending second query response data, the second query response data being based at least in part on the second subset of the query processing data for which the at least one proposition condition is true, and the second query response data comprising a second value for the first argument of the subject tuple.

4. The system of claim 1, the subset of the data for which the at least one proposition condition is true comprising a plurality of values for a first argument of the subject tuple and a plurality of values for a second argument of the subject tuple.

5. The system of claim 1, the first proposition body tuple being represented at the analytics computing system as a first proposition matrix, the second proposition body tuple being represented at the analytics computing system as a second proposition matrix, and the determining of the subset of query processing data for which the at least one proposition is true comprising executing a matrix operation using the first proposition matrix and the second proposition matrix.

6. The system of claim 1, the proposition body data further describing the subject tuple, the determining of the subset of query processing data for which the at least one proposition condition is true comprising:
evaluating the first proposition body tuple; and
evaluating the subject tuple recursively based at least in part on the evaluation of the first proposition body tuple.

7. The system of claim 1, the accessing of the analytics code further comprising:
accessing second proposition data that also corresponds to the subject tuple, the second proposition data comprising second proposition head data describing the subject tuple and second proposition body data describing at least one second proposition condition;
accessing second query processing data, the second query processing data being based at least in part on the second proposition body data; and
determining a subset of the second query processing data for which the at least one second proposition condition is true, the query response data also being based on the subset of the second query processing data for which the at least one second proposition condition is true.

8. The system of claim 1, the relationship between the first proposition body tuple and the second proposition body tuple indicating a conjunction between the first proposition body tuple and the second proposition body tuple.

9. The system of claim 1, the analytics code further comprising at least one operation using at least one argument of the first proposition body tuple and at least one argument of the second proposition body tuple, the operations further comprising using the subset of query processing data for which the at least one proposition condition is true, and evaluating the at least one operation, the query response data also being based at least in part on a result of the evaluating of the at least one operation.

10. A method, comprising:
receiving, by an analytics computing system and from a computing device, query data describing a query, the query data comprising an indication of a subject tuple;
accessing analytics code, by the analytics computing system, the analytics code comprising first proposition data corresponding to the subject tuple, the first proposition data comprising:
proposition head data describing the subject tuple; and
proposition body data describing at least one proposition condition, the at least one proposition condition comprising a relationship between a first proposition body tuple and a second proposition body tuple;
accessing, by the analytics computing system, query processing data, the query processing data comprising data associated with the first proposition body tuple and data associated with the second proposition body tuple;
determining, by the analytics computing system, a subset of the query processing data for which the at least one proposition condition is true; and
sending, by the analytics computing system and to the computing device, query response data, the query response data being based on the subset of the query processing data for which the at least one proposition condition is true.

11. The method of claim 10, the query data further comprising a value for a first argument of the subject tuple, the subset of the data for which the at least one proposition condition is true comprising a value for a second argument of the subject tuple.

12. The method of claim 11, further comprising:
receiving, by the analytics computing system, second query data describing a second query, the second query data comprising an indication of the subject tuple and a second value for the second argument of the subject tuple;
determining, by the analytics computing system, a second subset of the query processing data for which the at least one proposition condition is true, the second subset of the query processing data also being based at least in part on the second value for the second argument of the subject tuple; and
sending, by the analytics computing system, second query response data, the second query response data being based at least in part on the second subset of the query processing data for which the at least one proposition condition is true, and the second query response data comprising a second value for the first argument of the subject tuple.

13. The method of claim 10, the subset of the data for which the at least one proposition condition is true comprising a plurality of values for a first argument of the subject tuple and a plurality of values for a second argument of the subject tuple.

14. The method of claim 10, the first proposition body tuple being represented at the analytics computing system as a first proposition matrix, the second proposition body tuple being represented at the analytics computing system as a second proposition matrix, and the determining of the subset of query processing data for which the at least one proposition is true comprising executing a matrix operation using the first proposition matrix and the second proposition matrix.

15. The method of claim 10, the proposition body data further describing the subject tuple, the determining of the subset of query processing data for which the at least one proposition condition is true comprising:
evaluating the first proposition body tuple; and
evaluating the subject tuple recursively based at least in part on the evaluation of the first proposition body tuple.

16. The method of claim 10, the accessing of the analytics code further comprising:
accessing second proposition data that also corresponds to the subject tuple; the second proposition data comprising second proposition head data describing the subject tuple and second proposition body data describing at least one second proposition condition;
accessing second query processing data, the second query processing data being based at least in part on the second proposition body data; and
determining a subset of the second query processing data for which the at least one second proposition condition is true, the query response data also being based on the subset of the second query processing data for which the at least one second proposition condition is true.

17. The method of claim 10, the relationship between the first proposition body tuple and the second proposition body tuple indicating a conjunction between the first proposition body tuple and the second proposition body tuple.

18. The method of claim 10, the analytics code further comprising at least one operation using at least one argument of the first proposition body tuple and at least one argument of the second proposition body tuple, the method further comprising using the subset of query processing data for which the at least one proposition condition is true, evaluating the at least one operation, the query response data also being based at least in part on a result of the evaluating of the at least one operation.

19. A non-transitory machine-readable medium comprising instructions thereon that, when executed by at least one processor, cause the at least one processor to perform operations comprising:
receiving query data describing a query, the query data comprising an indication of a subject tuple;
accessing analytics code, the analytics code comprising first proposition data corresponding to the subject tuple, the first proposition data comprising:
proposition head data describing the subject tuple; and
proposition body data describing at least one proposition condition, the at least one proposition condition comprising a relationship between a first proposition body tuple and a second proposition body tuple;
accessing query processing data, the query processing data comprising data associated with the first proposition body tuple and data associated with the second proposition body tuple;
determining a subset of the query processing data for which the at least one proposition condition is true; and
sending query response data, the query response data being based on the subset of the query processing data for which the at least one proposition condition is true.

20. The medium of claim 19, the query data further comprising a value for a first argument of the subject tuple, the subset of the data for which the at least one proposition condition is true comprising a value for a second argument of the subject tuple.
